(19) United States
(12) Patent Application Publication
(10) Pub. No.: US 2016/0091267 A1
(43) Pub. Date: Mar. 31, 2016

(54) WEAPON SAFETY DEVICE

(71) Applicant: Armando Ray Mascorro, San Antonio, TX (US)

(72) Inventor: Armando Ray Mascorro, San Antonio, TX (US)

(21) Appl. No.: 14/497,525

(22) Filed: Sep. 26, 2014

(51) Int. Cl. F41A 17/06; G01K 13/00

(52) U.S. Cl. CPC F41A 17/066; G01K 13/002

(57) ABSTRACT

A weapon safety assembly includes a processor coupled to a weapon. The processor is coupled to a safety of the weapon such that the processor selectively enables and disables the safety. An electronic memory is coupled to the weapon and the processor. The electronic memory stores an authorized fingerprint record. A scanner is coupled to a trigger of the weapon such that the scanner may identify a fingerprint of a user. The scanner is electrically coupled to the processor. The processor enables the safety if the fingerprint of the user does not match the authorized fingerprint record such that the weapon is prevented from being fired. A temperature sensor is coupled to the weapon such that the temperature sensor may detect a temperature of the user.

### BACKGROUND OF THE DISCLOSURE

### Field of the Disclosure

The disclosure relates to safety devices and more particularly pertains to a new safety device for preventing an unauthorized user from firing a weapon.

### SUMMARY OF THE DISCLOSURE

An embodiment of the disclosure meets the needs presented above by generally comprising a processor coupled to a weapon. The processor is coupled to a safety of the weapon such that the processor selectively enables and disables the safety. An electronic memory is coupled to the weapon. The electronic memory is electrically coupled to the processor. The electronic memory stores an authorized fingerprint record. A scanner is coupled to a trigger of the weapon to detect a fingerprint of a user. The scanner is electrically coupled to the processor such that the processor disables the safety when the fingerprint of the user matches the authorized fingerprint record allowing the weapon to be fired. The processor enables the safety when the fingerprint of the user does not match the authorized fingerprint record wherein the weapon is prevented from being fired. A temperature sensor is coupled to the weapon such that the temperature sensor may detect a temperature of the user. The temperature sensor is electrically coupled to the processor such that the processor does not disable the safety unless the temperature sensor communicates a temperature to the processor that is above a minimum temperature.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a weapon safety assembly according to an embodiment of the disclosure.

FIG. 2 is a right side view of an embodiment of the disclosure.

FIG. 3 is a left side view of an embodiment of the disclosure.

FIG. 4 is a cross sectional view taken along line 4-4 of FIG. 2 of an embodiment of the disclosure.

FIG. 5 is a schematic view of an embodiment of the disclosure.

### DESCRIPTION OF THE PREFERRED EMBODIMENT

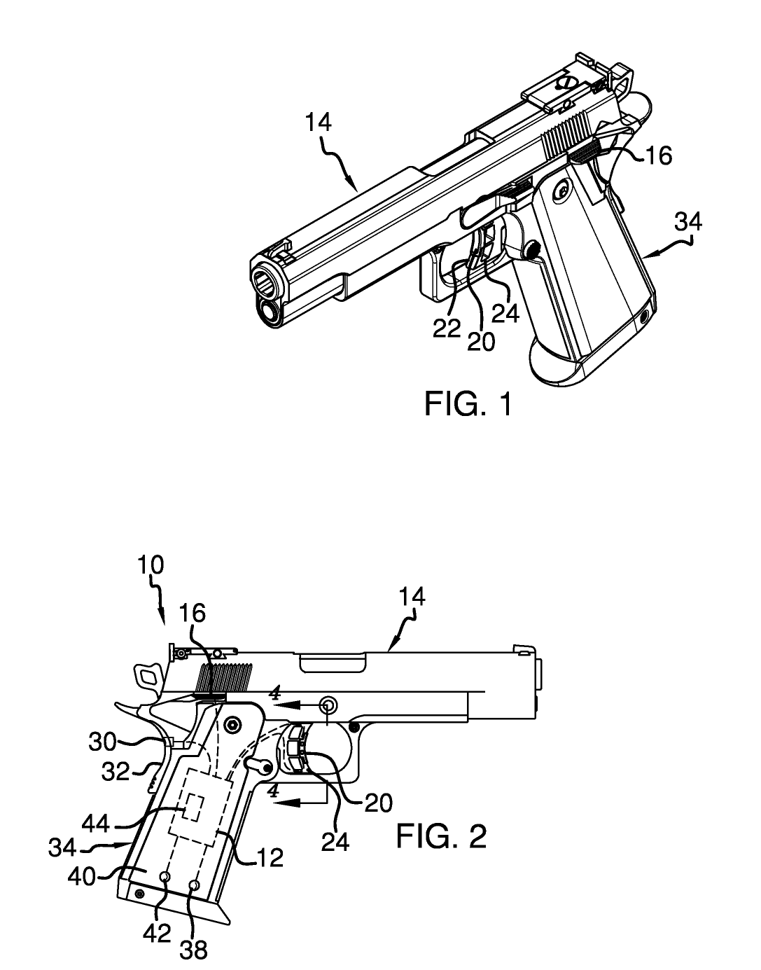

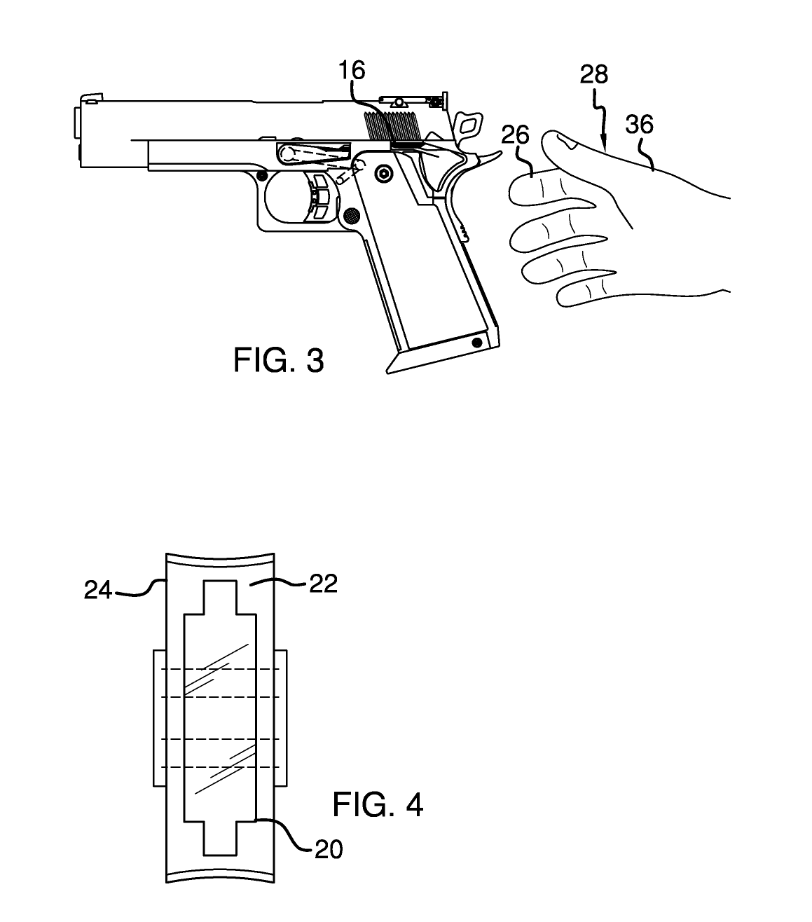

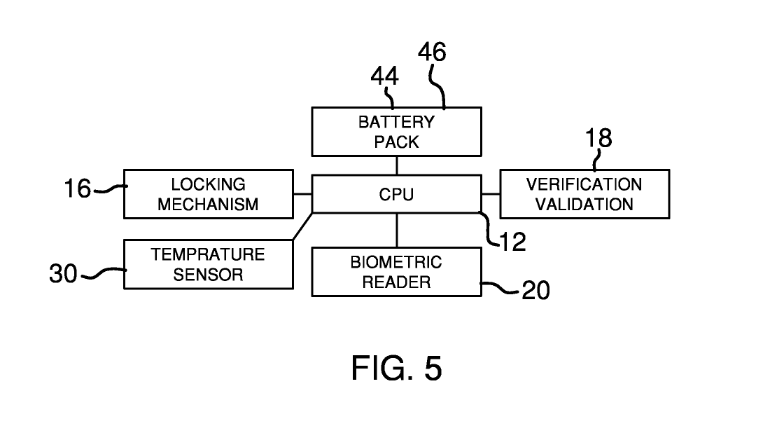

With reference now to the drawings, and in particular to FIGS. 1 through 5 thereof, a new safety device embodying the principles and concepts of an embodiment of the disclosure and generally designated by the reference numeral 10 will be described.

As best illustrated in FIGS. 1 through 5, the weapon safety assembly 10 generally comprises a processor 12 coupled to a weapon 14. The processor 12 is coupled to a safety 16 of the weapon 14 such that the processor 12 selectively enables and disables the safety 16. The weapon 14 may be a firearm or the like. Additionally, the processor 12 may be an electronic processor or the like.

An electronic memory 18 is coupled to the weapon 14. The electronic memory 18 is electrically coupled to the processor 12. Moreover, the electronic memory 18 stores an authorized fingerprint record.

A scanner 20 is provided. The scanner 20 is coupled to a leading edge 22 of a trigger 24 of the weapon 14 such the scanner 20 abuts a user's finger 26 when the user 28 attempts to pull the trigger 24. Thus, the scanner 20 may scan the user's finger 26 to determine a fingerprint of the user 28. The scanner 20 is electrically coupled to the processor 12 such that the processor 12 disables the safety 16 when the fingerprint of the user 28 matches the authorized fingerprint record. Consequently, the weapon 14 may be fired. The processor 12 enables the safety 16 if the fingerprint of the user 28 does not match the stored fingerprint of the authorized user such that the weapon 14 may be not fired. The scanner 20 may be a biometric scanner or the like.

A temperature sensor 30 is provided. The temperature sensor 30 is coupled to a back side 32 of a handle 34 of the weapon 14 such that the temperature sensor 30 may engage the user's hand 36 when the user 28 grips the handle 34 of the weapon 14. Thus, the temperature sensor 30 detects a temperature of the user 28. The temperature sensor 30 is electrically coupled to the processor 12 such that the processor 12 does not disable the safety 16 unless the temperature sensor 30 communicates a temperature to the processor 12 that is above a minimum temperature. The minimum temperature may be a temperature ranging between 85° Fahrenheit and 100° Fahrenheit.

A safe light emitter 38 is coupled to a first lateral side 40 of the handle 34 of the weapon 14. The safe light emitter 38 is electrically coupled to the processor 12. Thus, the safe light emitter 38 is illuminated when the processor 12 enables the safety 16. The safe light emitter 38 may have a green color.

A fire light emitter 42 is coupled to the first lateral side 40 of the handle 34 of the weapon 14. The fire light emitter 42 is electrically coupled to the processor 12. Thus, the fire light emitter 42 is illuminated when the processor 12 disables the safety 16. The fire light emitter 42 may have a red color.

A power supply 44 is coupled to the weapon 14. The power supply 44 is electrically coupled to the processor 12. The power supply 44 comprises at least one battery 46.

In use, the fingerprint of the authorized user is loaded into the electronic memory 18. The temperature sensor 30 prevents a severed finger of the authorized user from being used to disable the safety 16 of the weapon 14. Additionally, the assembly 10 prevents the weapon 14 from being utilized against the authorized user if the weapon 14 is forcibly removed from the authorized user.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A weapon safety assembly comprising:
a processor coupled to a weapon, said processor being coupled to a safety of the weapon such that said processor selectively enables and disables the safety;
an electronic memory coupled to the weapon, said electronic memory being electrically coupled to said processor, said electronic memory storing an authorized fingerprint record;
a scanner coupled to a trigger of the weapon such that said scanner is configured to identify a fingerprint of a user, said scanner being electrically coupled to said processor such that said processor disables the safety when the fingerprint of the user matches the authorized fingerprint record allowing the weapon to be fired, said processor enabling the safety if the fingerprint of the user does not match the authorized fingerprint record such that the weapon is prevented from being fired; and
a temperature sensor coupled to the weapon wherein said temperature sensor is configured to detect a temperature of the user, said temperature sensor being electrically coupled to said processor such that said processor does not disable the safety unless said temperature sensor communicates a temperature to said processor being above a minimum temperature.

2. The assembly according to claim 1, further comprising said scanner being coupled to a leading edge of the trigger of the weapon such said scanner is configured to abut the user's finger when the user attempts to pull the trigger.

3. The assembly according to claim 1, further comprising said temperature sensor being coupled to a back side of a handle of the weapons such that said temperature sensor is configured to engage the user's hand when the user grips the handle of the weapon.

4. The assembly according to claim 1, further comprising a safe light emitter coupled to a first lateral side of a handle of the weapon, said safe light emitter being electrically coupled to said processor, said safe light emitter being illuminated when said processor enables the safety.

5. The assembly according to claim 4, further comprising a fire light emitter coupled to the first lateral side of the handle of the weapon, said fire light emitter being electrically coupled to said processor, said fire light emitter being illuminated when said processor disables the safety.

6. The assembly according to claim 1, further comprising a power supply coupled to the weapon, said power supply being electrically coupled to said processor, said power supply comprising at least one battery.

7. A weapon safety assembly comprising:
a processor coupled to a weapon, said processor being coupled to a safety of the weapon such that said processor selectively enables and disables the safety;
an electronic memory coupled to the weapon, said electronic memory being electrically coupled to said processor, said electronic memory storing an authorized fingerprint record;
a scanner, said scanner being coupled to a leading edge of a trigger of the weapon such said scanner is configured to abut the user's finger when the user attempts to pull the trigger, said scanner scanning the user's finger wherein said scanner is configured to identify a fingerprint of a user, said scanner being electrically coupled to said processor such that said processor disables the safety when the fingerprint of the user matches the authroized fingerprint record allowing the weapon to be fired, said processor enabling the safety if the fingerprint of the user does not match the authorized fingerprint record such that the weapon is prevented from being fired;
a temperature sensor, said temperature sensor being coupled to a back side of a handle of the weapon such that said temperature sensor is configured to engage the user's hand when the user grips the handle of the weapon and to detect a temperature of the user, said temperature sensor being electrically coupled to said processor such that said processor does not disable the safety unless said temperature sensor communicates a temperature to said processor being above a minimum temperature;
a safe light emitter coupled to a first lateral side of the handle of the weapon, said safe light emitter being electrically coupled to said processor, said safe light emitter being illuminated when said processor enables the safety;
a fire light emitter coupled to the first lateral side of the handle of the weapon, said fire light emitter being electrically coupled to said processor, said fire light emitter being illuminated when said processor disables the safety; and
a power supply coupled to the weapon, said power supply being electrically coupled to said processor, said power supply comprising at least one battery.
